(19) United States
(12) Patent Application Publication
(10) Pub. No.: US 2012/0134502 A1
(43) Pub. Date: May 31, 2012

(54) Audio Correction Apparatus and Audio Correction Method

(76) Inventors: Yasuhiro Kanishima, Tokyo (JP); Toshifumi Yamamoto, Hino-shi (JP); Takanobu Mukaide, Tachikawa-shi (JP)

(21) Appl. No.: 13/172,654

(22) Filed: Jun. 29, 2011

(30) Foreign Application Priority Data
Nov. 26, 2010 (JP) 2010-263979

(51) Int. Cl. H04R 29/00

(52) U.S. Cl. 381/56

(57) ABSTRACT

According to one embodiment, audio correction apparatus connected to audio player, includes output module configured to output audio signal as sound, and filter configured to correct the audio signal based on tap coefficient is provided. The apparatus includes, audio measurement module configured to pick up plurality of recording signals obtained by recording sound output from output module at detection points located at different points, audio analyzer configured to calculate plurality of frequency responses based on plurality of recording signals obtained by audio measurement module, and audio correction module configured to calculate maximum amplitude response by specifying maximum amplitude for each of frequencies, to calculate average group delay property for each of frequencies, to calculate tap coefficient based on maximum amplitude and average group delay property, and to output tap coefficient to filter of audio player.

### CROSS-REFERENCE TO RELATED APPLICATIONS

This application is based upon and claims the benefit of priority from Japanese Patent Application No. 2010-263979, filed Nov. 26, 2010; the entire contents of which are incorporated herein by reference.

### FIELD

Embodiments described herein relate generally to an audio correction apparatus and an audio correction method.

### BACKGROUND

Conventionally, an audio correction apparatus is generally known, which outputs a sound from a loudspeaker to a predetermined space, detects the sound output from the loudspeaker with one or more microphones, and corrects the quality of the sound output from the loudspeaker based on the detected sound.

In order for an audience to be able to clearly hear the sound from the speaker no matter where he or she may be within the space, the audio correction apparatus measures frequency responses at a plurality of measurement points near a recommended listening point. The audio correction apparatus averages the measured frequency responses to calculate the power response, and thus corrects the quality of the sound output from the speaker.

However, in the case where a frequency response is measured at a plurality of measurement points, there are peaks (crests in the frequency response) and dips (trouphs in the frequency response) even for the same frequency depending on what measurement points are used for detection. For this reason, when the correction is performed based on a result of the averaging of a frequency which composed of peaks and dips mixedly, there are some cases where the correction is carried out to evaluate the peaks smaller than they should be or the dips larger than they should be depending on the point.

According to the studies on the auditory sensory, it is considered that listerners are generally more sensitive to peaks in a frequency response, whereas less sensitive to dips. Therefore, if the correction is performed to make the dips excessively large, it may cause such a drawback of creating an unpleasant sound for the audience.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing for explanation the structure of an audio correction apparatus according to an embodiment.

FIG. 2 is an exemplary view showing for explanation the process in the audio correction apparatus according to the embodiment.

FIG. 3 is an exemplary view showing for explanation the process in the audio correction apparatus according to the embodiment.

FIG. 4 is an exemplary view showing for explanation the process in the audio correction apparatus according to the embodiment.

FIG. 5 is an exemplary view showing for explanation the process in the audio correction apparatus according to the embodiment.

FIG. 6 is an exemplary view showing for explanation the process in the audio correction apparatus according to the embodiment.

FIG. 7 is an exemplary view showing for explanation the process in the audio correction apparatus according to the embodiment.

FIG. 8 is an exemplary view showing for explanation the process in the audio correction apparatus according to the embodiment.

FIG. 9 is an exemplary view showing for explanation the process in the audio correction apparatus according to the embodiment.

FIG. 10 is an exemplary view showing for explanation the process in the audio correction apparatus according to the embodiment.

FIG. 11 is an exemplary view showing for explanation the process in the audio correction apparatus according to the embodiment.

FIG. 12 is an exemplary view showing for explanation the process in the audio correction apparatus according to the embodiment.

FIG. 13 is an exemplary view showing for explanation the process in the audio correction apparatus according to the embodiment.

FIG. 14 is an exemplary view showing for explanation the process in the audio correction apparatus according to the embodiment.

### DETAILED DESCRIPTION

Various embodiments will be described hereinafter with reference to the accompanying drawings. In general, according to one embodiment, an audio correction apparatus connected to an audio player, comprising an output module configured to output an audio signal as a sound, and a filter configured to correct the audio signal based on a tap coefficient is provided. The apparatus comprises, a audio measurement module configured to pick up a plurality of recording signals obtained by recording the sound output from the output module at detection points located at different points, an audio analyzer configured to calculate a plurality of frequency responses based on the plurality of recording signals obtained by the audio measurement module, and an audio correction module configured to calculate a maximum amplitude response by specifying a maximum amplitude for each of frequencies based on the plurality of frequency responses calculated by the audio analyzer, to calculate an average group delay property for each of frequencies based on the plurality of frequency responses calculated by the audio analyzer, to calculate a tap coefficient based on the maximum amplitude and the average group delay property, and to output the tap coefficient to the filter of the audio player.

An audio correction apparatus and an audio correction method according to an embodiment will now be described in details with reference to accompanying drawings.

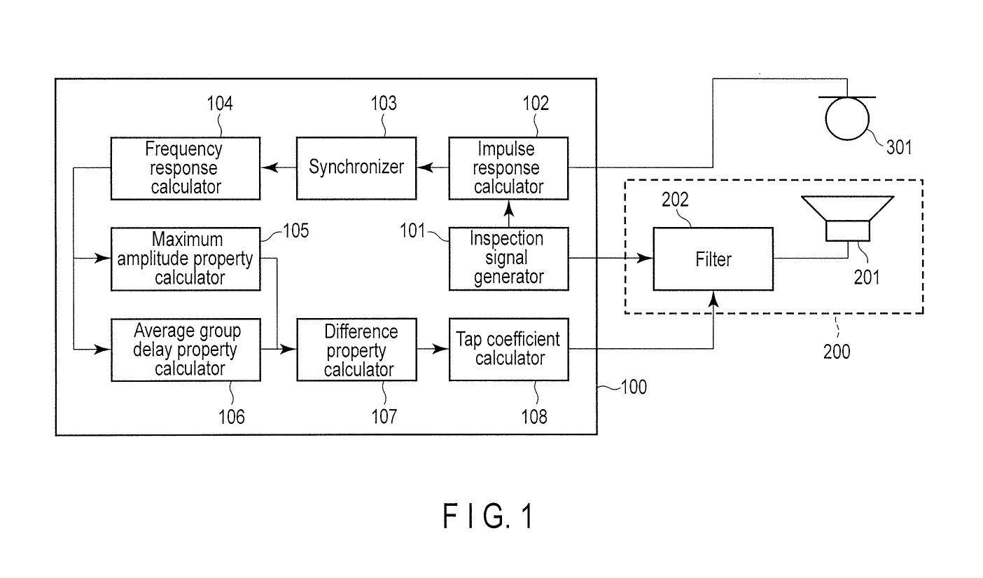

FIG. 1 is an exemplary view showing for explanation the structure of an audio correction apparatus 100 according to an embodiment.

As shown in FIG. 1, the audio correction apparatus 100 comprises an inspection signal generator 101, an impulse response calculator 102, a synchronizer 103, a frequency response calculator 104, a maximum amplitude property calculator 105, an average group delay property calculator 106, a difference property calculator 107, a tap coefficient calculator 108, and the like.

Further, the audio correction apparatus 100 is connected to an audio player 200. The audio player 200 comprises a loudspeaker 201, a filter 202 and the like. The loudspeaker 201 outputs a sound (sound wave) based on a signal supplied. The filter 202 comprises, for example, a finite impulse response (FIR) filter. The filter 202 performs the signal processing on a signal supplied to the loudspeaker 201 based on the set filter coefficient.

The inspection signal generator 101 generates an inspection signal and an inverted signal to the inspection signal. The inspection signal generator 101 supplies the generated inspection signal to the audio player 200. Further, the inspection signal generator 101 supplies the generated inverted signal to the inspection signal to the impulse response calculator 102. The loudspeaker 201 of the audio player 200 reproduces the supplied inspection signal and thus output the sound.

Meanwhile, the audio correction apparatus 100 is connected to a microphone 301. The microphone 301 picks up the sound output from the loudspeaker 201, and convertes the sound into an electric signal (recording signal). The microphone 301 supplies the recording signal to the audio correction apparatus 100. In other words, the microphone 301 functions as an audio measurement module.

It should be noted that the inspection signal generator 101 generates a plurality of inspection signals and supplies these signals continuously to the loudspeaker 201. In this manner, the loudspeaker 201 continuously outputs the sounds based on the inspection signals. Further, the microphone 301 continuously detects the sounds and obtains a plurality of recording signals. The microphone 301 supplies the obtained recording signals successively to the audio correction apparatus 100.

The impulse response calculator 102 calculates a plurality of impulse responses by subjecting the recording signals supplied from the microphone 301 and the inverted signals to the inspection signals supplied from the inspection signal generator 101 to convolution. The synchronizer 103 synchronizes the impulse responses with each other. The frequency response calculator 104 calculates a plurality of frequency responses based on the synchronized impulse responses.

That is, the impulse response calculator 102, the synchronizer 103 and the frequency response calculator 104 function as an audio analyzer which analyses the audio characteristics of the loudspeaker.

The maximum amplitude property calculator 105 calculates the maximum amplitude property based on the frequency responses. The average group delay property calculator 106 calculates the average group delay property based on the frequency responses. The difference property calculator 107 calculates the difference amplitude property between the preset target amplitude property and the maximum amplitude property. Further, the difference property calculator 107 calculates the difference group delay property between the preset target group delay property and the average group delay property. The tap coefficient calculator 108 calculates the tap coefficient based on the difference amplitude property and the difference group delay property. The tap coefficient calculator 108 supplies the calculated tap coefficient to the filter 202 of the audio player 200. That is, the maximum amplitude property calculator 105, the average group delay property calculator 106, the difference property calculator 107 and the tap coefficient calculator 108 function as an audio correction module which calculates the tap coefficient.

The filter 202 performs the signal process on the signals supplied to the loudspeaker 201 based on the tap coefficient supplied from the tap coefficient calculator 108. In this manner, the audio correction apparatus 100 can correct the sounds output from the audio player 200.

The operation of each module will now be explained in more detail.

The inspection signal generator 101 generates a pink time stretch pulse represented by, for example, the mathematical formula 1 provided below, as an inspection signal H. Further, the inspection signal generator 101 generates a signal (inverse property signal) H⁻¹ having a property inversed to that of the pink time stretch pulse and represented by the mathematical formula 2. Furthermore, the inspection signal generator 101 may be configured to generate an inspection signal based on the method for, for example, whitenoise, pinknoise, bandnoise or the like.

$$\begin{matrix}H ( k ) = \{ \begin{matrix}1 , & k = 0 \\ \frac{exp ( j ak log k )}{\sqrt{k}} , & 0 \leq k \leq \frac{N}{2} \\ {H}^{*} ( N - k ) , & \frac{N}{2} < k < N\end{matrix} & ( mathematical formula 1 ) \\ {H}^{- 1} ( k ) = \{ \begin{matrix}1 , & k = 0 \\ \sqrt{k} exp ( - j ak log k ) , & 0 \leq k \leq \frac{N}{2} \\ {H}^{- {1}^{*}} ( N - k ) , & \frac{N}{2} < k < N\end{matrix} & ( mathematical formula 2 )\end{matrix}$$

It should be noted that in the mathematical formulas 1 and 2 provided above, H represents a frequency response, H⁻¹ represents an inverted frequency response and N represents a signal length. In this case, the following mathematical formula 3 is established.

$$a ( \frac{N}{2} ) log ( \frac{N}{2} ) = 2 m π \qquad ( mathematical formula 3 )$$

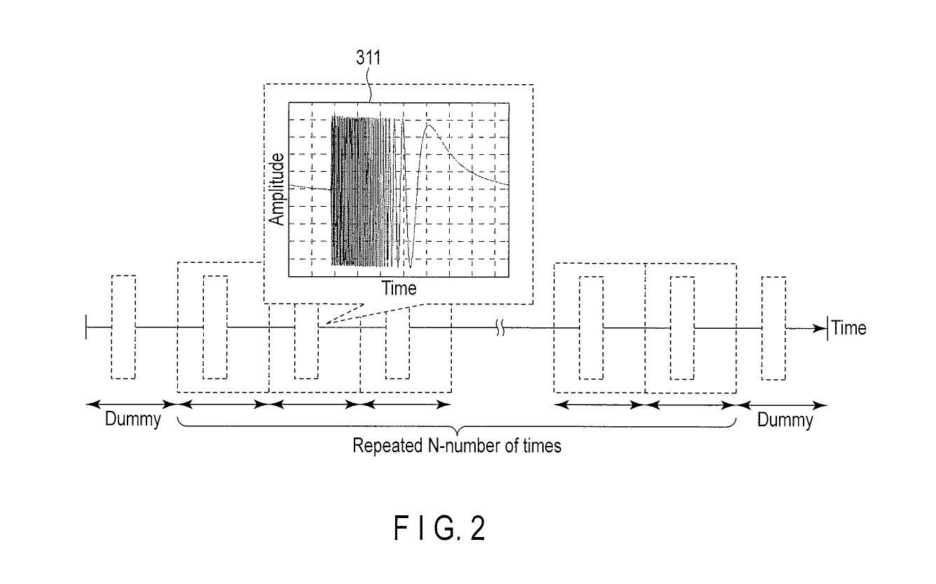

The inspection signal generator 101 repeatedly generates an inspection signal periodically a predetermined number of times (for example, N times). FIG. 2 is an exemplary view showing for explanation the inspection signal generated by the inspection signal generator 101. The inspection signal generator 101 repeatedly generates an inspection signal having a waveform 311 as shown in FIG. 2 N times. It should be noted that the inspection signal generator 101 places one dummy inspection signal immediately before and after the N inspection signals in order to prevent the discontinuity of the inspection signals.

The inspection signal generator 101 supplies the generated inspection signals to the audio player 200. Further, the inspection signal generator 101 supplies the generated inverse property signals to the impulse response calculator 102. The inspection signals supplied from the inspection signal generator 101 are allowed to pass the filter 202 and reproduced by the loudspeaker 201. In this manner, the sounds for the N times of the signals plus 2 times for the dummy signals are output from the loudspeaker 201. Note that the filter 202 is set to a gain of 0 dB at all frequencies in the initial state, that is, the flat response. Therefore, at this stage, the filter 202 does not perform a substantial signal process.

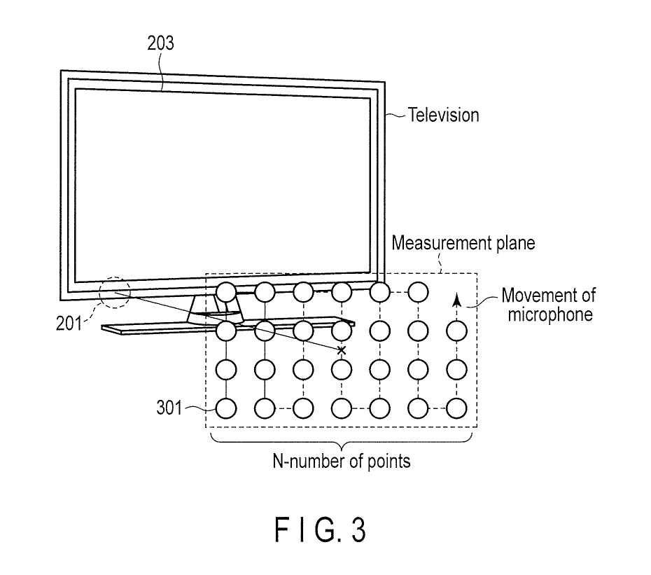

The sounds output from the loudspeaker 201 are recorded with the microphone 301. FIG. 3 is an exemplary view for explanation an example of the structure of the microphone 301 shown in FIG. 1. It should be note that the explanations here will be made on the assumption that the audio player 200 is a part of, for example, a television comprising a loudspeaker 201 and a display 203.

The microphone 301 is, as shown in FIG. 3, placed at a position opposing the loudspeaker 201 mounted in the audio player 200. The microphone 301 picks up the sounds output from the loudspeaker 201 for recording, while moving on a plane opposing the loudspeaker 201 (measurement plane), and recording signals are obtained. The impulse response calculator 102 successively receives the recording signals obtained with the microphone 301.

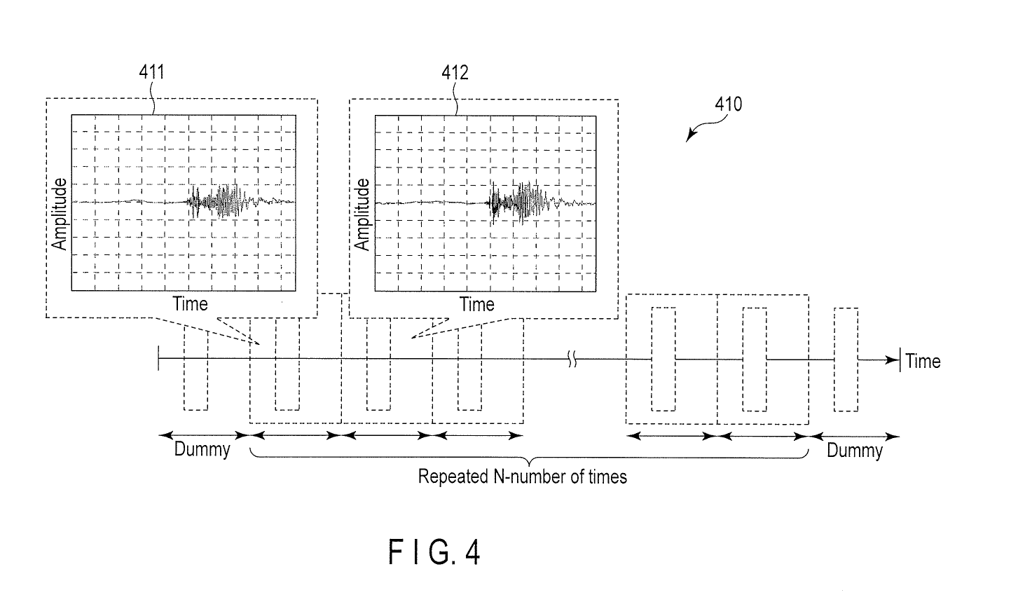

The microphone 301 picks up the sound one time at each of an N-number of detection points on the measurement plane. In this manner, the microphone 301 picks up N-number of successive recording signals 410 as shown in FIG. 4. That is, these recording signals 410 have a plurality of respective waveforms recorded at the detection points located at different points.

It should be noted that in the above-described case, the distance between the loudspeaker 201 and the microphone 301 at each of the detection points differs one from another. Therefore, the arrival time of each of the waveforms of the recording signals 410 obtained with microphone 301 is not constant, but differs one waveform from another. In other words, a waveform 411 and another waveform 412 are deviated from each other in timing as shown in FIG. 4.

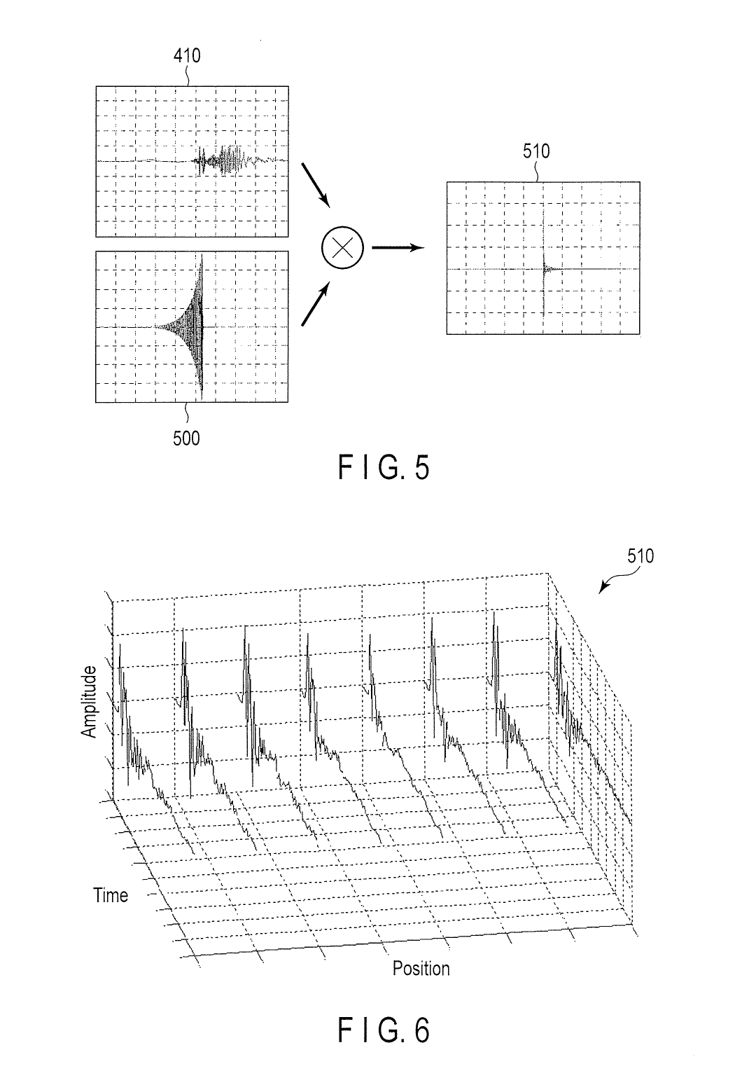

FIG. 5 is an exemplary view showing the process in the impulse response calculator 102.

As shown in FIG. 5, the recording signals 410 and inversion property signals 500 generated by the inspection signal generator 101 are input to the impulse response calculator 102. It should be noted that the recording signals 410 contains consecutive N-number of waveforms as shown in FIG. 4.

The impulse response calculator 102 calculates by convolution the inversion property signals supplied from the inspection signal generator 101 for the respective waveforms of the recording signals 410 supplied from the microphone 301. In this manner, the impulse response calculator 102 calculates N-number (N points) of impulse responses 510 as shown in FIG. 6. It should be noted that the impulse response calculator 102 may alternatively be configured to calculate the impulse responses 510 by multiplication in the frequency region.

The synchronizer 103 performs the synchronization process onto the impulse responses 510 calculated by the impulse response calculator 102. As mentioned above, in the case where the recording signals 410 are obtained while moving the microphone 301 continuously, the calculated impulse responses 510 are deviated from each other in timing due to the difference in the distance between the loudspeaker 201 and the microphone 301 from one point to another or Dopplers shift. Therefore, the synchronizer 103 carries out the process of align the first peak times, for example, based on the calculated impulse responses 510, and thus adjusts the time deviation between the impulse responses 510.

Further, the synchronizer 103 may alternatively be configured to adjust the time deviation by performing the up-sampling process and further adjust the time deviation between the impulse responses 510 by performing the down-sampling process when the time resolution is not sufficient.

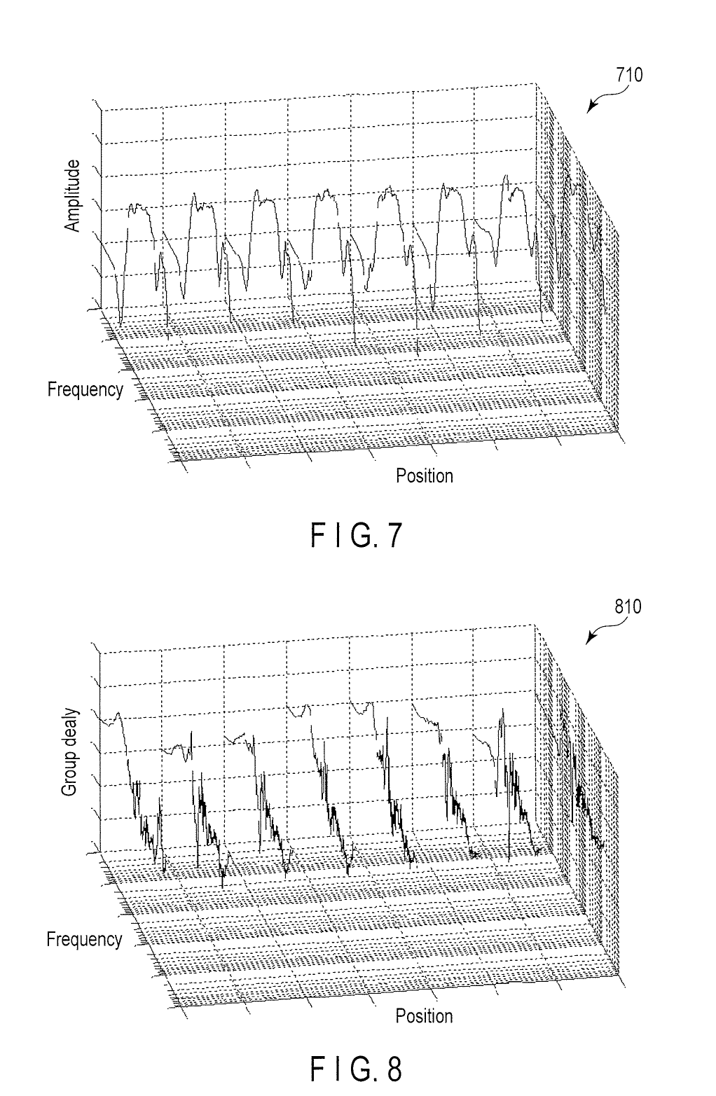

The frequency response calculator 104 performs Fourier transformation on the impulse responses 510 subjected to the synchronization process by the synchronizer 103, and thus calculates an amplitude property 710 shown in FIG. 7 and a group delay property 810 shown in FIG. 8.

For example, the frequency response calculator 104 subjects each of the impulse responses 510 to the Fourier transformation, and calculates the absolute value for each of the Fourier-transformed impulse responses, thereby obtaining the amplitude property 710. That is, as shown in FIG. 7, the frequency response calculator 104 obtains N-number of amplitude properties 710. Further, for example, the frequency response calculator 104 subjects each of the impulse responses 510 to the Fourier transformation, and performs partial differentiation on the angle of each of the Fourier-transformed impulse responses in the complex plane, thereby obtaining the group delay property 810. That is, as shown in FIG. 8, the frequency response calculator 104 obtains N-number of group delay properties 810.

The frequency response calculator 104 may alternatively be configured to multiply the window function to the impulse responses 510, and further perform the Fourier transformation. In this case, the data of the area other than the zone designated by the window function are all “0”, and therefore the numerical analysis is facilitated.

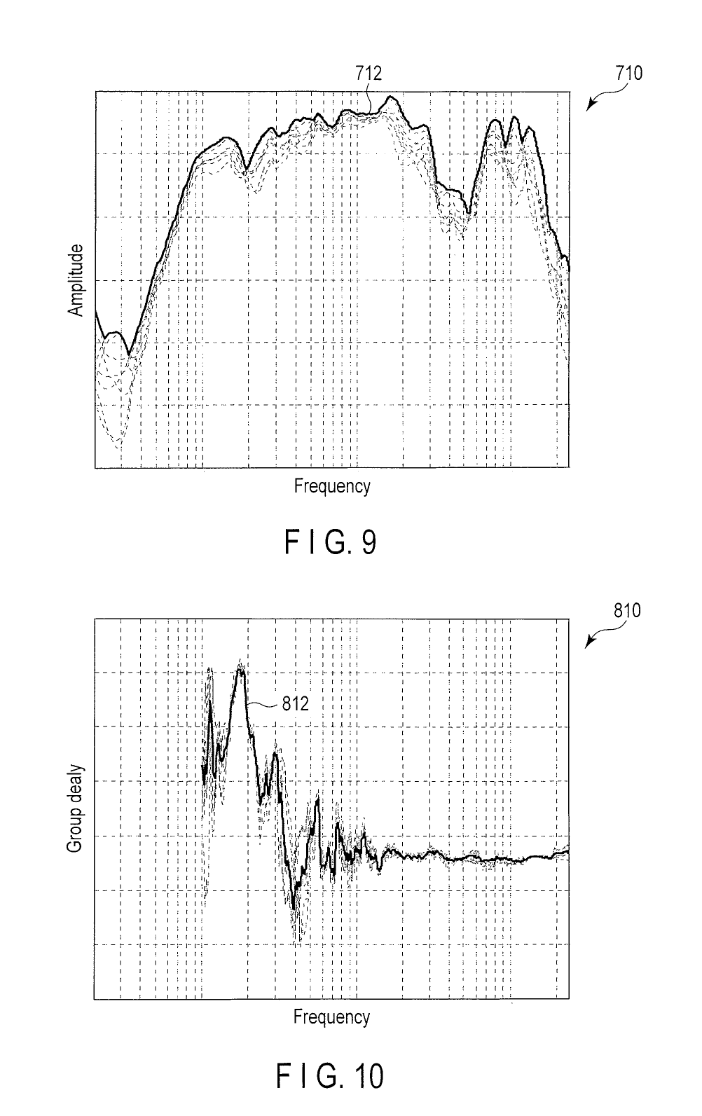

The maximum amplitude property calculator 105 calculates a maximum amplitude property 712 shown in FIG. 9 based on the N-number of amplitude properties 710 calculated by the frequency response calculator 104. Dotted lines shown in FIG. 9 each indicate an amplitude property. For example, the maximum amplitude property calculator 105 calculates the maximum amplitude property 712 by calculating the maximum value in the N-number of amplitude properties 710 for each of the frequencies. Further, the maximum amplitude property calculator 105 may alternatively configured to calculate the maximum value by excluding the values which fall out of the normal distribution based, for example, on the histogram of the amplitude value for each of the frequencies, by which the operation is not affected by a singular point.

The average group delay property calculator 106 calculates an average delay group property 812 shown in FIG. 10 based on the N-number of delay group properties 810 calculated by the frequency response calculator 104. Dotted lines shown in FIG. 10 each indicate a delay group property. For example, the average group delay property calculator 106 calculates the average delay group property 812 by calculating the average value in the N-number of delay group properties 812 for each of the frequencies. Further, the average group delay property calculator 106 may alternatively configured to calculate the average value by excluding the values which fall out of the normal distribution based on, for example, the histogram of the group delay value for each of the frequencies, by which the operation is not affected by a singular point.

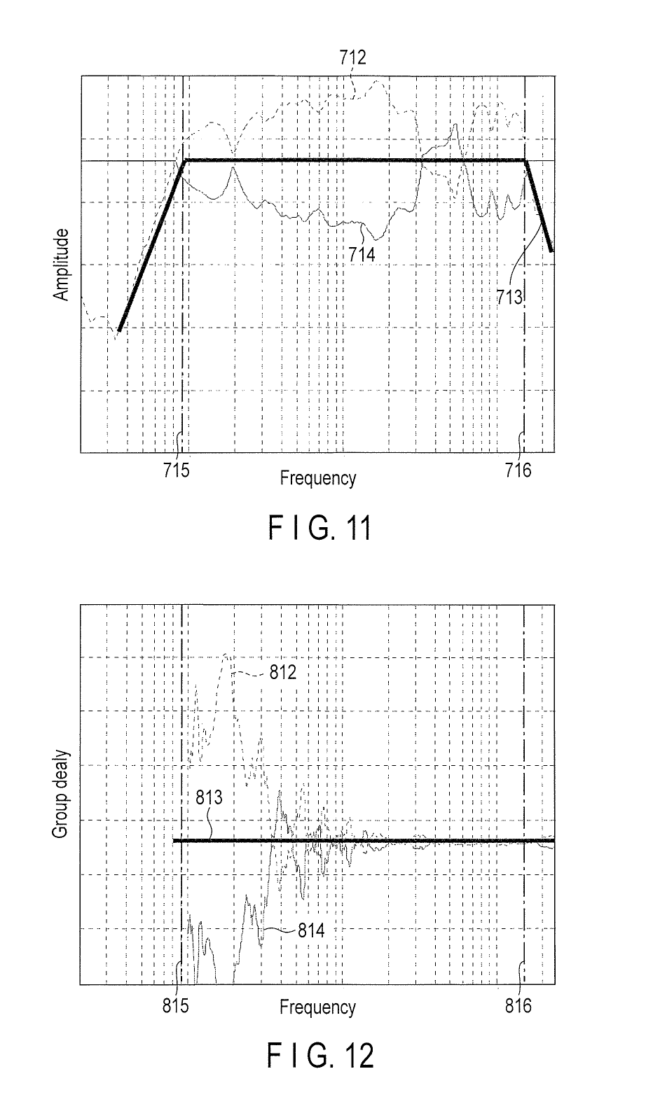

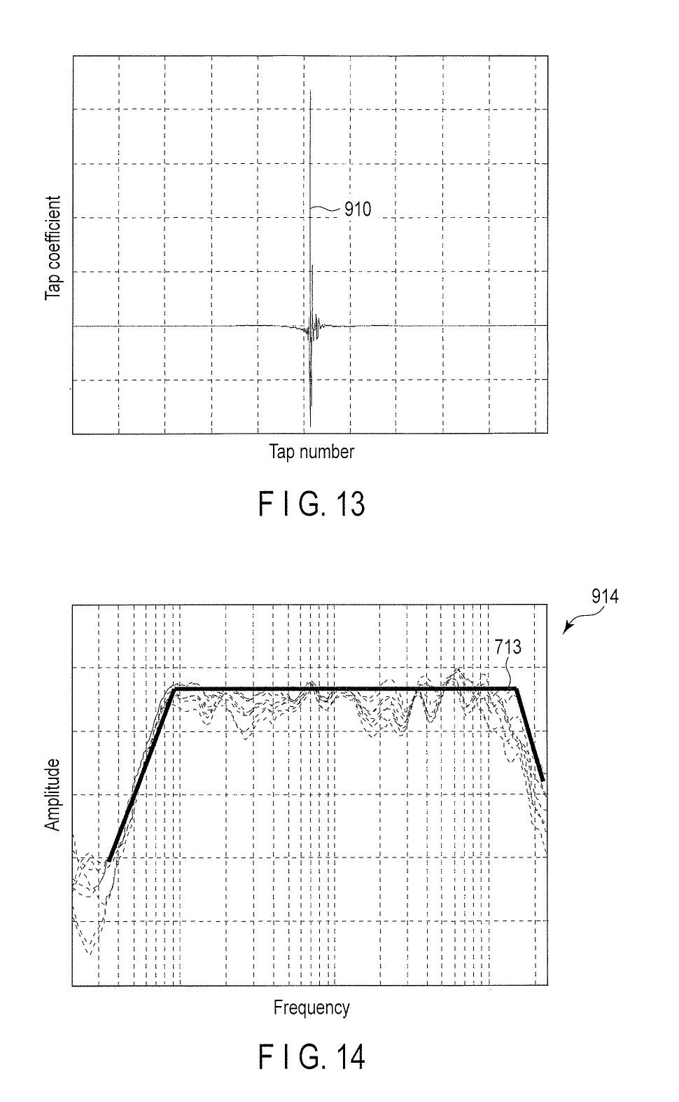

As shown in FIG. 11, the difference property calculator 107 calculates a difference amplitude property 714 between the maximum amplitude property 712 calculated by the maximum amplitude property calculator 105 and a preset target amplitude property 713. For example, the difference property calculator 107 subtracts the maximum amplitude property 712 calculated by the maximum amplitude property calculator 105 from the preset target amplitude property 713 in a logarithmic region, thereby calculating the difference amplitude property 714.

Further, as shown in FIG. 12, the difference property calculator 107 calculates a difference group delay property 814 between the average group delay property 812 calculated by the average group delay property calculator 106 and a preset target group delay property 813. For example, the difference property calculator 107 subtracts the average group delay property 812 calculated by the average group delay property calculator 106 from the preset target group delay property 813, thereby calculating the difference group delay property 814.

Here, an example of the case described above is shown in FIGS. 11 and 12 on the assumption that the preset target amplitude property 713 and the preset target group delay property 813 are both flat properties in the frequency range to be subjected to the correction. Note that the object of correction for the preset target amplitude property 713 is in the inner side defined by border lines 715 and 716, and the object of correction for the preset target group delay property 813 is in the inner side defined by border lines 815 and 816.

It should be noted that the preset target amplitude property 713 and the preset target group delay property 813 used in the audio correction apparatus 100 are preset in the above-explained example, but the embodiment is not limited to this configuration. For example, the audio correction apparatus 100 may alternatively comprise a module which receives an operation input signal entered by the user, and be configured to adjust the preset target amplitude property 713 and the preset target group delay property 813 based on the operation input signal received.

The tap coefficient calculator 108 calculates an impulse response (the tap coefficient of FIR filter) 910 by carrying out inverse Fourier transformation based on the difference amplitude property and the difference group delay property.

The tap coefficient calculator 108 supplies the calculated tap coefficient 910 to the filter 202 of the audio player 200. The filter 202 retains the tap coefficient 910 supplied from the audio correction apparatus 100, and carries out a signal process on the audio signal supplied to the loudspeaker 201 using the retained tap coefficient 910. In this manner, the audio correction apparatus 100 can correct the sound output from the audio player 200.

FIG. 14 is a diagram showing a waveform 914 of the sound output from the loudspeaker 201, subjected to audio correction based on the tap coefficient 910 supplied from the audio correction apparatus 100.

According to the conventional audio correction, a peak in a frequency response, in some cases, exceeds the target response in some positions. As a result, an unpleasant sound to the user may be created in the produced sound.

However, as shown in FIG. 14, according to the audio correction apparatus 100 and the audio player 200, the peak exceeding the target amplitude property 713 can be suppressed.

As described above, the audio correction apparatus 100 according to this embodiment calculates the maximum amplitude property 712 based on a plurality of amplitude properties 710 detected at different points, and also calculates the average group delay property 812 based on a plurality of group delay properties 810 detected at different points. Further, the audio correction apparatus 100 calculates the difference amplitude property 714 and the difference group delay property 814 based on the preset target amplitude property 713 and the preset target group delay property 813. Further, the audio correction apparatus 100 carries out inverse Fourier transformation based on the difference amplitude property 714 and the difference group delay property 814, thereby calculating the tap coefficient 910 to be used in the filter.

In this manner, the audio correction apparatus 100 corrects the sound based on the recording signals detected at the detection points, thereby making it possible to eliminate the peak components which may be felt by the user to be unpleasant as a sound. Thus, this apparatus can provide sounds free of components which cause unpleasant feeling to the user regardless of the place where the use may be.

In other words, the audio correction apparatus 100 calculates the tap coefficient 910 for the object of the correction, which is the maximum value of each of the amplitude properties measured at a plurality points at each frequency. In this manner, the audio correction apparatus 100 can correct peaks intensively rather than dips. Thus, the audio correction apparatus 100 can reduce unpleasant sounds present in the space in which the sounds are propagated.

Consequently, this embodiment can provide an audio correction apparatus and an audio correction method, which can realize a high quality sound in a wide area in terms of the auditory sensory.

It should be noted that in the above-described embodiment, the filter 202 is described to be an FIR filter, but it may be formed of some other type of filter. When some other type of filter is used, the audio correction apparatus 100 calculates a filter coefficient 910 according to the type of the filter used for the audio player 20 based on the difference amplitude property 714 and the difference group delay property 814.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An audio correction apparatus connected to an audio player, comprising an output module configured to output an audio signal as a sound, and a filter configured to correct the audio signal based on a tap coefficient; the apparatus comprising:
an audio measurement module configured to pick up a plurality of recording signals obtained by recording the sound output from the output module at detection points located at different points;
an audio analyzer configured to calculate a plurality of frequency responses based on the plurality of recording signals obtained by the audio measurement module; and
an audio correction module configured to calculate a maximum amplitude response by specifying a maximum amplitude for each of frequencies based on the plurality of frequency responses calculated by the audio analyzer, to calculate an average group delay property for each of frequencies based on the plurality of frequency responses calculated by the audio analyzer, to calculate a tap coefficient based on the maximum amplitude and the average group delay property, and to output the tap coefficient to the filter of the audio player.

2. The audio correction apparatus of claim 1, wherein the audio measurement module transmits a generated inspection signal to the output module of the audio correction apparatus, picks up the plurality of recording signals obtained by recording the sound output from the output module based on the inspection signal at the detection points located at the different points, generates an inverse property signal having a property inverse to that of the inspection signal and transmits the inverse property signal to the audio analyzer.

3. The audio correction apparatus of claim 2, wherein the audio analyzer calculates a plurality of impulse responses based on the inverse property signal generated by the audio measurement module, and calculates a plurality of amplitude responses and group delay properties based on the plurality of impulse responses.

4. The audio correction apparatus of claim 3, wherein the audio correction module calculates the maximum amplitude response by calculating a maximum value in the plurality of amplitude responses for each of frequencies, calculates the average group delay property by calculating an average value in the plurality of group delay properties for each of frequencies, calculates the tap coefficient based on the maximum amplitude property, the average group delay property, a preset target amplitude property and target group delay property, and outputs the tap coefficient to the filter of the audio player.

5. An audio correction method for an audio correction apparatus connected to an audio player, comprising an output module configured to output an audio signal as a sound, and a filter configured to correct the audio signal based on a tap coefficient; the method comprising:
picking up a plurality of recording signals obtained by recording the sound output from the output module at detection points located at different points;
calculating a plurality of frequency responses based on the plurality of recording signals picked up;
calculating a maximum amplitude response by specifying a maximum amplitude for each of frequencies based on the plurality of frequency responses, and calculating an average group delay property for each of frequencies based on the plurality of frequency responses;
calculating a tap coefficient based on the maximum amplitude and the average group delay property; and
outputting the tap coefficient to the filter of the audio player.
